(19) United States
(12) Patent Application Publication
(10) Pub. No.: US 2022/0060019 A1
(43) Pub. Date: Feb. 24, 2022

(54) Passive Parallel Neutral Electromatic Converter

(71) Applicants: Richard G. Baker, Lakeland, FL (US); William R. Thomas, Lakeland, FL (US); Kenneth H. Baker, Lakeland, FL (US)

(72) Inventors: Richard G. Baker, Lakeland, FL (US); William R. Thomas, Lakeland, FL (US); Kenneth H. Baker, Lakeland, FL (US)

(21) Appl. No.: 17/408,946

(22) Filed: Aug. 23, 2021

Related U.S. Application Data
(60) Provisional application No. 63/068,463, filed on Aug. 21, 2020.

(51) Int. Cl. H02J 3/01; H02J 3/18

(52) U.S. Cl. CPC H02J 3/01; H02J 3/18

(57) ABSTRACT

The present disclosure provides converter 10 that comprises a plurality of wires 20 30 40, a transformer 80 which is connected to the electric panel 70 via wires 20 30 40, and optionally a capacitor 50 and a resistor 60.

### CROSS REFERENCE TO PENDING APPLICATIONS

This application claims priority to, and the benefit of, pending U.S. Provisional Patent Application No. 63/068,463 filed Aug. 21, 2020.

### FIELD OF THE DISCLOSURE

The present disclosure pertains to the field electronics and power factor correction. More specifically, the present disclosure pertains to a converter that reduces the reactive power component of an AC circuit.

### BACKGROUND

Power factor correction is known to reduce the reactive power component of AC power to improve the efficiency of the AC circuit. Power factor correction is an important component of increasing efficiency of modern-day power delivery systems. Due to reactive components in the loads that consume power such as appliances that include a motor, a phase shift develops between a current and a voltage component of a power signal. As shown in FIG. 1, it is known that that the apparent power of a system is greater than the real power of the system. Apparent power is the used by most, if not all, utility companies as the power for which a client is charged. The reason the apparent power of the system is higher than the real power is reactive power which is created by inefficiencies in the system. In an AC system, a certain amount of waste is created by harmonics. Ideally, as shown in FIG. 2, the AC voltage is a perfect sine wave, however, for various reasons harmonics, as shown in FIG. 3, distort the sine wave and create power loss and other inefficiencies which lead to increased apparent power and higher utility rates. Therefore, it is desirable to have a low-cost converter that can reduce the harmonics in an AC system.

### BRIEF DESCRIPTION OF THE DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows the relationship between real power, apparent power and reactive power.

FIG. 2 shows the normal sine wave for AC current.

FIG. 3 shows harmonics and other distortions with the normal sine wave for AC current.

FIG. 4 shows one embodiment of the converter 10 provided herein.

FIG. 5 shows one embodiment of connecting the converter 10 to an electric panel.

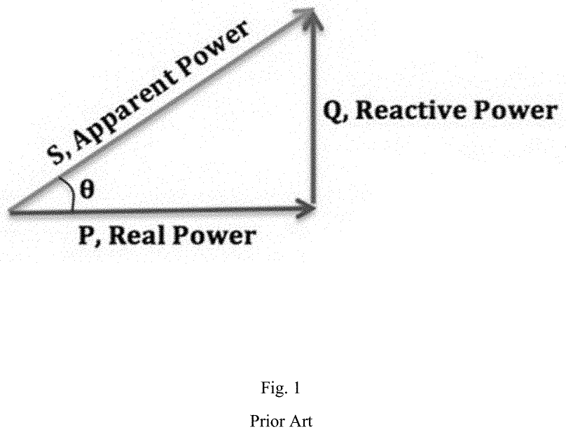

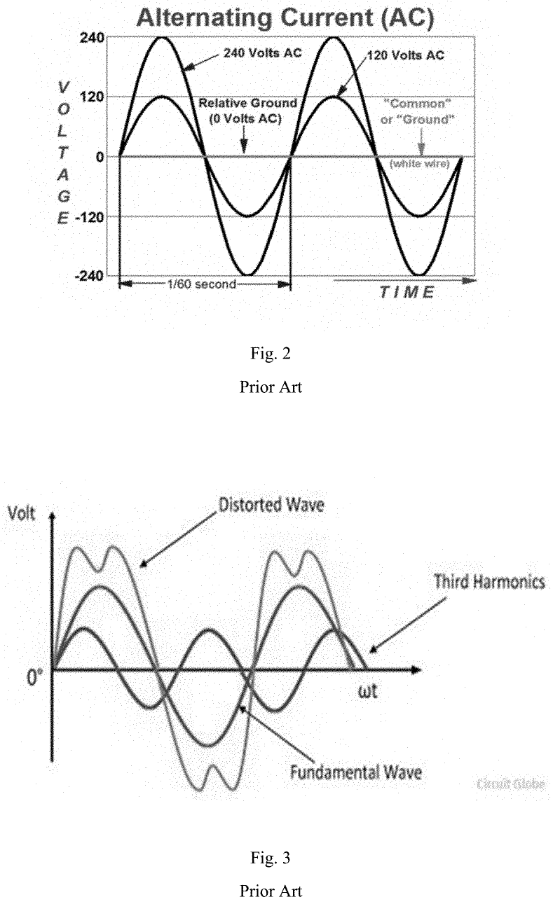

### DETAILED DESCRIPTION

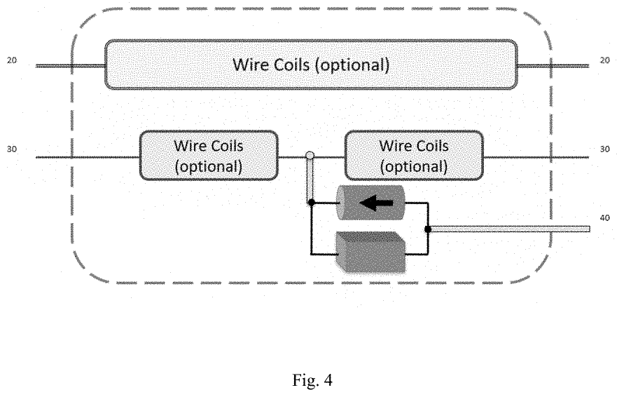

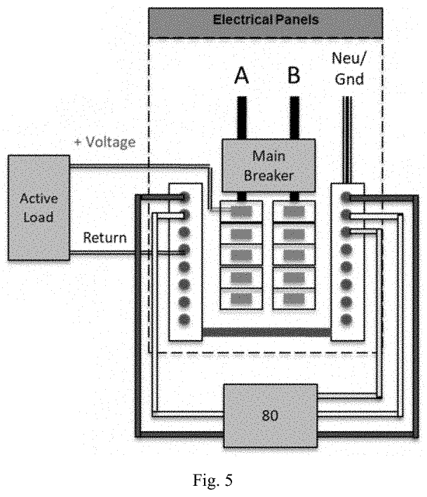

As shown in FIGS. 4 and 5, the present disclosure provides a passive converter 10 that connects to an electric panel 70 and converters out, or reduces, the harmonics naturally created in an AC system. The converter 10 comprises a plurality of wires 20 30 40, a transformer 80 which is connected to the electric panel 70 via wires 20 30 40, and optionally a capacitor 50 and a resistor 60. The converter 10 is passive as it does not require any electrical energy to function properly.

In a typical AC electric panel 70 installation, there are “hot” leads entering the electric panel 70 from the electricity source and a number of neutral or ground leads 90A 90B 90C 90D 90E. For example, a device (the active load 100) which requires electricity to operate will be connected to a hot lead and a neutral or ground lead. The electric panel 70 includes a series return buss where all service panel active loads 100 compete for electron flow, this competition and the electron crowding resulting therefrom causes restrictions, spikes and harmonics to develop. The converter 10 provided herein uses a parallel return buss that provides different paths for the electrons to flow, thus eliminating the crowding and the resulting restrictions, spikes and harmonics. The converter 10 eliminates the circuit characteristics that demand instantaneous excessive demands for electrons due to lack of current availability from earth ground. It has multiple parallel paths to supply any instantaneous circuit demands. It satisfies the need for electrons immediately which eliminates/removes circuit characteristics that would require spikes. The converter 10 is designed to eliminate the circuits need for a spike. The end result is that the reactive power present in the system is reduced, thus lowering utility bills and costs.

In one embodiment, the converter 10 provided herein is connected via wires 20 30 40 to certain neutral or ground leads inside of the electric panel 70. In particular, wire 20 is connected to the second neutral or ground lead (90B and 90E) from the top on each side of the electric panel and to the transformer 80. Wire 30 is then connected to the top neutral or ground lead (90A and 90D) on each side of the electric panel 70. Finally, wire 40 is connected to the third neutral or ground lead (90C) on one side of the electric panel 70. After each of the wires 20 30 40 is connected to the electric panel 70 at one end, the other end of the wires 20 30 40 are connected to a transformer 80 as shown in FIG. 5. The wires 20 30 provide for more electron buffering thereby removing the potential for current crowding within the system.

In some embodiments, it may be desirable to increase the length of wires 20 and 30 to provide a longer wire length which will allow the converter 10 more time to remove the disruptive harmonics in the system. Accordingly, in these embodiments wires 20 and 30 may be coiled thereby increasing their length but in a space saving and efficient manner. The addition of extra lengths of wires 20 30 provide for more electron buffering thereby removing the potential for current crowding within the system.

Wire 40 may have a capacitor 50 and resistor 60 within its run to further help converter out the disruptive harmonics in the system.

Additionally, on many installations of the converter 10, it will be desirable to enclose the capacitor 50, resistor 60 and transformer 80 inside of a weatherproof enclosure or box (not shown). This will protect those structures from the elements as well as tampering.

Although particular embodiments of the present disclosure have been described, it is not intended that such references be construed as limitations upon the scope of this disclosure except as set forth in the claims.

We claim:

1. A method of removing remove disruptive harmonics and spikes from an alternating current power system, said method comprising connecting a passive neutral electric converter which further comprises a parallel return buss connected to an electric panel, wherein the passive neutral electric converter comprises at least a plurality of wires connected to a plurality of neutral or ground leads on the electric panel and a transformer.

2. The method of claim 1 wherein the passive neutral electric converter also comprises a capacitor and a resistor.

3. The method of claim 1 wherein at least one of the plurality of wires is coiled.

4. The method of claim 2 wherein at least one of the plurality of wires is coiled.

5. A method of removing remove disruptive harmonics and spikes from an alternating current power system, said method comprising connecting a passive neutral electric converter which further comprises parallel return buss connected to an electric panel, wherein the passive neutral electric converter comprises at least a plurality of wires connected to a plurality of neutral or ground leads on the electric panel, a transformer, a capacitor and a resistor.

6. The method of claim 5 wherein at least one of the plurality of wires is coiled.

7. A passive neutral electric converter which comprises a parallel return buss connected to an electric panel, wherein the passive neutral electric converter comprises at least a plurality of wires connected to a plurality of neutral or ground leads on the electric panel and a transformer.

8. The converter of claim 7 wherein the passive neutral electric converter also comprises a capacitor and a resistor.

9. The converter of claim 7 wherein at least one of the plurality of wires is coiled.

10. The converter of claim 8 wherein at least one of the plurality of wires is coiled.
